(19) United States
(12) Patent Application Publication
(10) Pub. No.: US 2010/0289804 A1
(43) Pub. Date: Nov. 18, 2010

(54) SYSTEM, MECHANISM, AND APPARATUS FOR A CUSTOMIZABLE AND EXTENSIBLE DISTRIBUTED RENDERING API

(75) Inventors: Thomas M. Jackman, Hawthorne, NY (US); James T. Klosowski, Hawthorne, NY (US); Christopher J. Morris, Hawthorne, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/465,357

(22) Filed: May 13, 2009

(51) Int. Cl. G06F 13/14

(52) U.S. Cl. 345/520

(57) ABSTRACT

A system and method for providing an Application Programming Interface (API) that allows users to write complex graphics and visualization applications with little knowledge of how to parallelize or distribute the application across a graphics cluster. The interface enables users to develop an application program using a common programming paradigm (e.g., scene graph) in a manner that accommodates handling parallel rendering tasks and rendering environments. The visualization applications written by developers take better advantage of the aggregate resources of a cluster. The programming model provided by APT function calls handles scene-graph(s) data in a manner such that the scene and data management are decoupled from the rendering, compositing, and display. As a result, the system and method is not beholden to one particular graphics rendering API (e.g. OpenGL, Direct X, etc.) and provides the ability to switch between these APIs even during runtime.

### CROSS-REFERENCES TO RELATED APPLICATIONS

The present invention relates to commonly-owned, co-pending U.S. patent application Ser. No. ______, [Atty. Docket No. YOR920090059US1 (24069)] filed on even date herewith.

### BACKGROUND OF THE INVENTION

1. Field of the Invention

The present invention relates generally to parallel and distributed graphics programming, and more particularly to a novel visualization toolkit that implements clustering for visualization applications.

2. Description of the Prior Art

With the advent of more powerful and less expensive computing hardware components (e.g. GPUs, CPUs, communication interconnect, displays, etc.), it is becoming increasingly practical, economical, and effective to pool these resources together and harness their aggregate capabilities in the form of a cluster. This philosophy is especially evident in the increasing popularity of graphics clusters or clusters designed specifically for providing high-performance graphics capabilities.

FIG. 1 depicts a block diagram of a current graphics display system 10 (visualization system) as known in the art. Referring to FIG. 1, a visualization system 10 includes a software application 12 running, for example, on a host data processing system 20. The application 12 may use a special local display server 30. The display server 30 of the application 12 is virtualized through the use of a local network 24 (e.g., Ethernet) linking to a rendering cluster or “graphics cluster” 40 comprising a plurality of server computing devices or workstations 41-44. Each of the servers 41-44 is used to draw a portion of the graphics output on individual displays 51-54. The special display server 30 accepts standard calls made by the application 12, encodes them, and performs the same function call onto each node of the cluster 40 of rendering servers 41-44. Each member of the cluster 40 receives the function call data and draws its portion of the final image 45 in parallel. Each rendering server 41-44 displays a portion 51-54 of the image. This may be, for example, as a tile of a display wall or projection system.

In order to make the best use of these graphics clusters, there needs to be a programming model that can effectively make use of the cluster' resources to address the particular task at hand while, at the same time, hiding enough of the complexity of programming distributed graphics systems to make it appealing to potential users who may not have substantial experience with these systems.

Currently, there exists challenges including, but not limited to: the distribution of data across the cluster nodes, the variation in data access times (CPU, GPU, local disk, remote disk), the rendering load balancing across the cluster nodes, and, the programming complexity, flexibility, and extensibility.

There have been attempts to address many of these same problems (see for example, U.S. Pat. No. 5,798,770 entitled “Graphics Rendering System with Reconfigurable Pipeline Sequence” and, for example, the reference to Whitman, Scott entitled “A Task Adaptive Parallel Graphics Renderer”. 1993 Symposium on Parallel Rendering. 1993. pp. 27-34. These prior art system have been either designed for a specific hardware configuration (e.g., such as the hardware configuration described in U.S. Pat. No. 6,753,878 entitled “Parallel Pipelined Merge Engines”), a specific distributed rendering scenario (e.g., such as described in U.S. Pat. No. 7,075,541 entitled “Adaptive Load Balancing in a Multi-Processor Graphics Processing System”, or U.S. Pat. No. 6,885,376 entitled “System, Method, and Computer Program Product for Near-Real Time Load Balancing Across Multiple Rendering Pipelines”), or does not provide support for scalable parallel rendering (U.S. Pat. No. 6,215,495 and U.S. Pat. No. 6,456,290), or is not application aware (e.g., such as described in the reference to Humphreys, G. et al. entitled “Chromium: A Stream-Processing Framework for Interactive Rendering on Clusters.” ACM Transactions on Graphics. Vol. 21. No. 3. pp. 693-702. 2002).

One reference in particular, referred to as the OpenGL MPK (e.g., such as described in the reference to Bhaniramka, P. et al. entitled “OpenGL Multipipe SDK: A Toolkit for Scalable Parallel Rendering”. IEEE Visualization 2005. pp. 119-126. October 2005. Minneapolis, USA.) seeks to address many of these problems and provides a flexible architecture for performing several parallel rendering tasks. However a major difference, the SGI MPK eschews the use of a scene graph (see, e.g., U.S. Pat. No. 6,933,941) in order to implement several of their optimization techniques and, therefore, forgo the benefits of using a scene-graph style data structure.

Thus, it would be highly desirable to address these problems by providing a system and method for creating an application that invokes application program interface (API) function calls enabling graphics application programmers to control the operation of rendering graphics in a clustered rendering environment and one that is able to handle the most common of parallel rendering tasks (e.g., screen partitioning or “sort-first” and data partitions or “sort-last”) and rendering environments (e.g., rendering to a single display or rendering to multiple or tiled displays) while allowing the user to develop their application using a common and familiar programming paradigm (e.g., a scene graph).

That is, it would be highly desirable to provide a system and method for creating an application program interface (that enables graphics application programmers to control the operation of rendering graphics in a clustered rendering environment using a programming model that makes use of familiar scene-graph(s) data.

### SUMMARY OF THE INVENTION

The present invention is directed to a distributed parallel visualization toolkit providing a system and method that addresses many of the challenges of parallel and distributed graphics programming.

In a further aspect of the invention, there is provided a graphics system programming interface enabling users to control the operation of rendering graphics in a clustered graphics rendering environment.

The interface enables users to develop their application program using a common and familiar programming paradigm (i.e., the scene graph) in a manner that accommodates handling parallel rendering tasks and rendering environments.

In the system and method of the invention, several features are provided to enhance the utility and effectiveness for high-end graphics or visualization applications, including: the ability to run on commodity graphics clusters; the ability to drive high-resolution, multi-tiled displays or projector systems; its support for surface and volumetric data; its support for static and dynamic data; its support for sort-first and sort-last parallel rendering (common parallel rendering paradigms); its support for multiple rendering “engines” that can be user-defined and changed at runtime; its support for datasets that are too large to completely reside in main memory; interactive frame rates via a variety of optimizations including novel load balancing techniques; the ability to interact with the cluster “back-end” with remote “front-end” applications which may be written in a variety of languages; it support for a visualization cluster “back-end” that can be implemented in Linux or Windows; and, the ability to extend beyond the native functionality of the invention.

With the system and methodology of the invention, developers are enabled to: 1) write visualization applications that take better advantage of clusters (in terms of rendering as well as application logic); 2) hide the complexity of parallel and distributed programming; and, 3) minimize the effort to port applications by using familiar interfaces.

In one aspect, the present invention comprises a front-end application including a software architecture comprising three separate layers: 1) a Presentation layer for handling the user interaction; 2) a Domain layer for implementing the application; and, 3) a Storage layer for interfacing with databases and file systems.

Moreover, in one aspect of the invention, as many programmers have familiarity with use of scene-graph(s) data structure(s), the programming model provided by the invention makes use of this familiar scene-graph(s) data.

Furthermore, in one aspect of the invention, the invention decouples the scene and data management from the rendering, compositing, and display. As a result, the invention is not beholden to one particular graphics rendering API (e.g. OpenGL, Direct X, etc.) and provides the ability to switch between these APIs even during runtime.

Finally, in one aspect of the invention, the invention provides the ability for the user to easily extend or customize the system to their hardware system environment as well as their visualization or rendering tasks. The areas that can be customized include the GUI or “front-end”, the rendering engine that can be used to render the data, the type of “back-end service” that can be used (e.g. sort-last, sort-first, simulation tracking and steering etc.), how load balancing operations are performed, and the way the results will be composited, transmitted, and displayed.

Thus, in one aspect of the invention, there is provided a system, method and computer program product for controlling rendering of visualization data at one or more display devices associated with one or more server computing devices forming a visualization graphics cluster, the method comprising:

generating, for display at a front end client computing device, a user interface receiving user input for enabling interaction with the one or more server computing devices of the visualization graphics cluster;

accessing, in response to received user input, application programming interface (API) functions comprising computer readable instructions for configuring rendering and displaying images at the one or more display devices of the graphics cluster; and,

instantiating, via the API functions, one or more back end processes at the one or more server computing devices for parallelizing rendering tasks associated with display graphics rendering in the visualization graphics cluster,

wherein multiple user-defined rendering engines are dynamically configured for parallel rendering under user control.

Further to this aspect, a back end process comprises a controller process responsive to API function calls for generating a scene graph model for display at said graphics cluster, said scene graph model specifying one or more scene graph nodes having associated data and descriptions of how said data is to be rendered. The back end controller process invokes a server process associated with each one or more scene graph nodes that is responsible for rendering a scene graph by generating resulting pixels for a display. The server process invokes a further rendering process for rendering a scene graph according to a user defined technique, the rendering process being decoupled from said scene graph model.

Advantageously, the toolkit of the present invention runs on a variety of different platforms, remotely, and potentially in a collaborative setting. The SGI MPK has not demonstrated this flexibility or extensibility.

### BRIEF DESCRIPTION OF THE FIGURES

The objects, features and advantages of the present invention will become apparent to one skilled in the art, in view of the following detailed description taken in combination with the attached drawings, in which:

FIG. 1 is an illustration depicting an example clustered (graphics) rendering environment in accordance with the prior art;

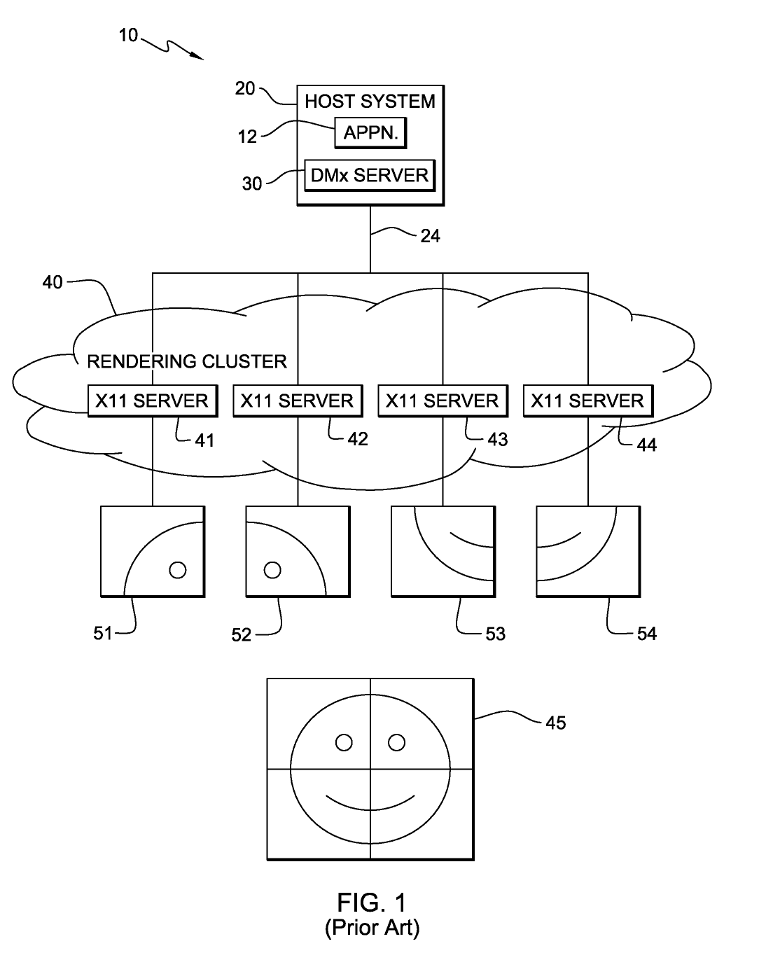

FIG. 2 illustrates a hardware and software design framework 10 according to the present invention; and,

FIG. 3 illustrates a first example embodiment of a system 200 implementing a back-end cluster of workstations 140 that are used to generate pixels that are sent to a developer workstation (client device);

FIG. 4 illustrates a second example embodiment of a system 225 comprising an example design review with display wall scenario wherein a back-end workstation cluster 140 uses a sort-first rendering paradigm to address the situation of the rendering task being too great for a single rendering node, e.g., thin client device 203;

FIG. 5 illustrates an initialization procedure 400 for generating a new graphics application using the visualization design framework for interactive visualization of data in a graphics cluster according to the invention;

FIG. 6 depicts a High-Level System Architecture and Operation Forwarding techniques 500 according to the invention;

FIG. 7 illustrates an example scene graph 250 depicting how Group nodes can be modeled in the scene graph; and,

FIG. 8 is a block diagram of an exemplary computing environment in which this invention may be implemented.

### DETAILED DESCRIPTION OF THE PREFERRED EMBODIMENTS

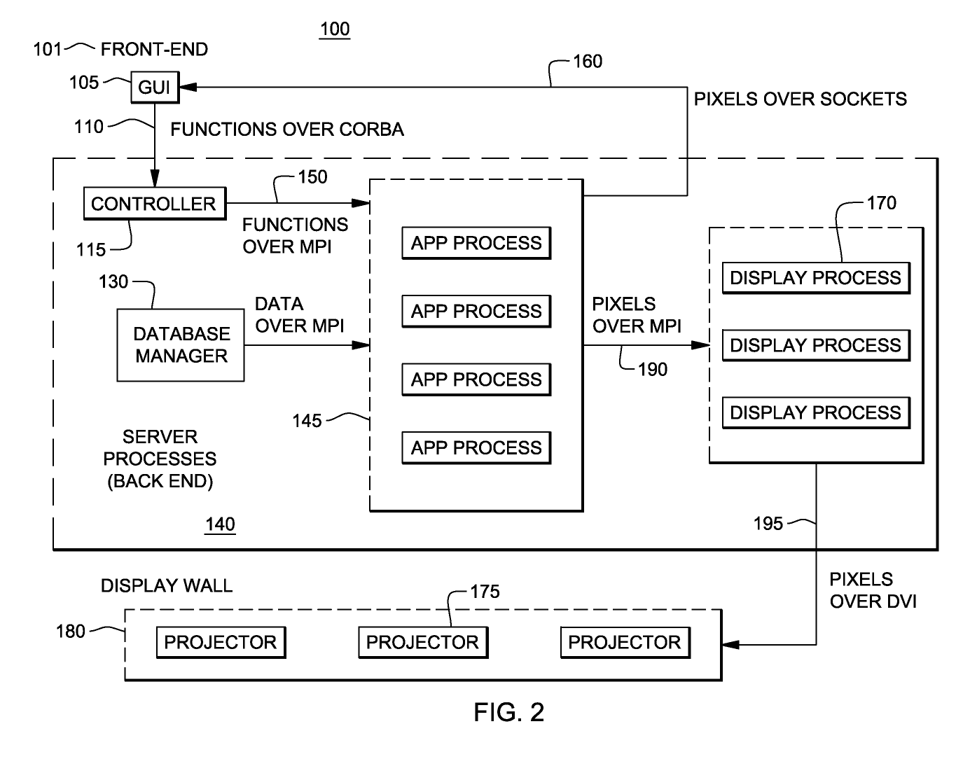

As shown in FIG. 2, there is depicted a computer system-based design framework 100 enabling users, e.g., developers, to write visualization applications that take better advantage of the aggregate resources of a graphics cluster. The computer system-based design framework 100 provides a distributed parallel visualization toolkit allowing users to write complex graphics and visualization applications with little knowledge of how to parallelize or distribute the application across the graphics cluster.

More specifically, referring to FIG. 2, the design framework 100 includes a system front-end 101 implementing a graphics user interface (GUI) and display device 105 providing an interface for the user that enables access to the cluster controller functions 150 through an object interface, e.g., such as a CORBA® interface (CORBA® is a Trademark of Object Management Group, Inc., www.omg.org). Thus, the front-end 101 may be written in any language supported by the CORBA® Interface Definition Language (IDL) compiler (for example, C++, Java, or Python). The controller 115 forwards function calls 110 from the front-end to application server 140 or servers forming a visualization cluster. The application server(s) renders images (e.g. image tiles), communicating with a database manager 130 to read or update parts of a scene being rendered. The database manager 130 interfaces with a file system (not shown).

All server processes 145 running in the cluster communicate with each other via MPI (message passing interface) 150. A server process 145 does not have to run on a dedicated machine. In other words, there may be multiple server processes 145 per physical machine. To enable remote visualization, the application server(s) 140 send pixels back to the front-end using sockets 160. In one embodiment, the front-end 101 accesses the cluster remotely via a network, e.g., LAN, WAN, the Internet, an intranet, etc. Further, in one embodiment, each application server includes a “tile sender” object that sends image tiles to the tile receiver object in the front-end. The user specifies, via an API, whether or not the tiles should be compressed. A “tile receiver” object runs on a separate thread, and makes the tiles available to a main thread in no particular order. This scheme allows the main thread to draw the available tiles in parallel with the transmission of the other tiles. To enable immersive visualization, the application servers' may also send image tiles to the display processes that run on the machines that are connected to projectors 175 that make up the display wall 180. In this case, the tile sender objects use MPI, as opposed to a socket, as the MPI implementation provided by a network vendor is highly optimized and typically gives much lower latency and two to three times more bandwidth than sockets.

The aforementioned parallel visualization toolkit is provided on a host computing system providing a visualization application that comprises three distinct layers: 1) a Presentation layer for handling the user interaction; 2) a Domain layer for implementing the application; and, 3) a Storage layer for interfacing with databases and file systems.

The Presentation Layer provides the user-interface of the application, i.e., the system front-end 101 that may be as simple or as complex as desired by the application writer. It is the responsibility of the developer to write the user-interface for the application, including all the buttons, bells, and whistles that are required for manipulating the user's point of view of the data, as well as the data itself in more complicated applications. That is, the application's user-interface will translate the user's actions, e.g. keystrokes, mouse movements, buttons pressed, into the appropriate API calls, which are then transferred over to the visualization server(s) 140. In one embodiment, the invention does not interpret mouse and keyboard events as these events are handled by the application. That is, these mouse and keyboard events are translated into the appropriate API calls. As an example, mouse events to manipulate the viewpoint when looking at a scene is interpreted by the application, which then passes the new camera information (including eye position, field of view, up vector, etc.) to the visualization cluster. The front-end can run on almost any machine, including laptops with limited graphics capabilities. As needed, the pixels generated on the graphics cluster can be brought back to the front-end for display within the user-interface. The front-end can be written in any number of languages that is supported by the CORBA IDL compiler, such as C++, Java, or Python and in example embodiments, the application includes a Front-Ends written in C++ using GLX, GLUT, and wxWidgets.

The Domain Layer is the core logic of the visualization design tool of the invention. Within this layer, there is provided a distributed scene graph for modeling the scene and a rendering engine which traverses the scene graph to produce the pixel output. At this level, the invention completely separates the scene graph modeling from the rendering engine, so that one can implement the rendering algorithms using various rendering APIs or techniques, e.g., OpenGL, DirectX, or even ray-tracing. This is one of the features that distinguishes the present invention from the products that support only OpenGL (ie. the SGI MPK). The invention's scene graph provides support for polygonal and volumetric models and may be easily extended to incorporate new features. Multiple parallel rendering algorithms are also supported by the present invention.

The Storage Layer acts as the interface between the domain layer and data stored on file systems across the visualization cluster, e.g., NFS, or GPFS. The invention provides several data readers for common file formats, and permits the end-user to expand the invention by registering their own data readers.

As previously mentioned, advantageously, the complexity of parallel, distributed programming is hidden from the application developer. The implementation of the distributed shared memory model of the invention provides the illusion that all machines have all the data in core at all times, which greatly simplifies the application's logic. Through novel caching and prefetching mechanisms, each rendering node will only load the data it needs as it needs it.

That is, as a critical part of any system for large data visualization is the memory management subsystem, the design toolkit of the present invention, keeps in a cache in main memory, the most recently used objects. This approach is particularly effective if the objects that are visible in any given frame fit together in the cache, and there is locality of reference, i.e., the changes in visibility from frame to frame are small. In one embodiment, the design toolkit of the invention implements caching by using the proxy pattern and swaps parts of the scene in and out memory automatically when necessary. The programmer does not have to make any explicit requests to the cache, and thus has the illusion that all the scene is in memory. Moreover, a technique to reduce cache misses is speculative prefetching, which attempts to bring into memory the objects that may become visible in a near time frame, e.g., soon, which is defined in one sense as the ability to have the objects in which users are interested ready in memory when they are needed, but, without polluting the cache with too many objects that will end up not being used. Traditional prefetching techniques use precomputed, from-region, conservative visibility algorithms that partition the dataset into cells, and precompute the cells that can be visible from within each cell. One prefetching strategy that may be employed in the invention that avoids polluting the cache, is an online, from-point approximate visibility algorithm. Based on the recent history of camera motion, a separate thread guesses cameras for the next few frames, estimates the nodes that these cameras would see, and prefeches these nodes. Because the visibility algorithm is online, it requires much less preprocessing time. Because it is from-point, it tends to cause less cache pollution. And because prefetching is speculative in nature, an approximate algorithm is appropriate.

These out-of-core techniques enables the system 100 to handle datasets that are significantly larger than the entire aggregate RAM of the graphics cluster. In the context of the invention, “out-of-core techniques” refers to techniques designed to process data that is too large to completely reside in a computer's main memory.

Thus, the invention's combination of three features (support for: different rendering engines, datasets larger than aggregate RAM, and multiple parallel rendering algorithms) differentiate the invention from the prior art. A fourth feature that may be added is a rich set of optimization tools that are included for achieving the interactive rendering frame rates that high-performance computing customers demand. These optimization tools include: hierarchical spatial subdivisions, visibility culling techniques, adaptive and flexible load balancing, and level-of-detail construction and management. By combining these four features, the present invention is able to scale application performance in terms of output pixel resolution, overall frame rates, and most importantly data size.

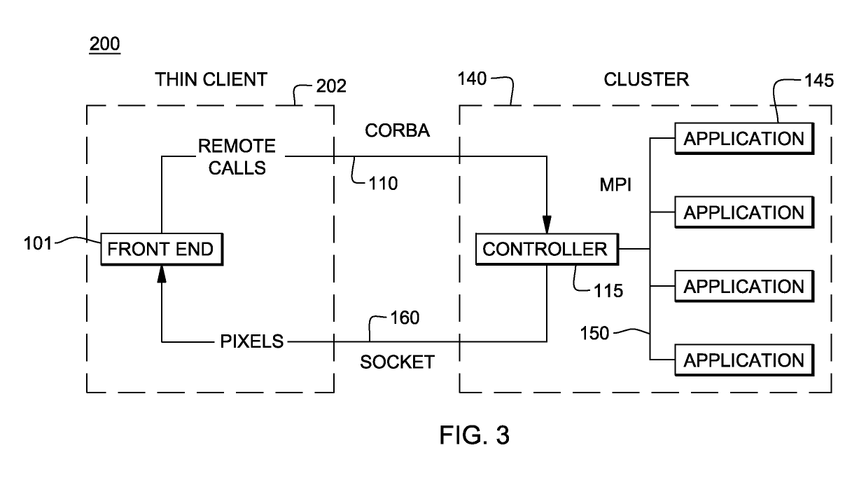

FIG. 3 illustrates one example embodiment comprising a first scenario 200 including a back-end cluster of workstations 140 that are used to generate pixels which are sent to a workstation, e.g., an engineer's office workstation (client device) 202. The Engineer's Desktop scenario employs a “sort-last” rendering paradigm to address the situation where a cluster of rendering nodes are producing pixels for a single display. Typically, this scenario presents itself when the data models are too large to render on one workstation, e.g., a “thin” client 202, due to limited main memory, limited texture memory on the graphics card, or insufficient frame rate because of the rendering complexity. It is understood, however, that the Engineer's Desktop scenario shown in FIG. 3 can also employ a “sort-first” rendering paradigm.

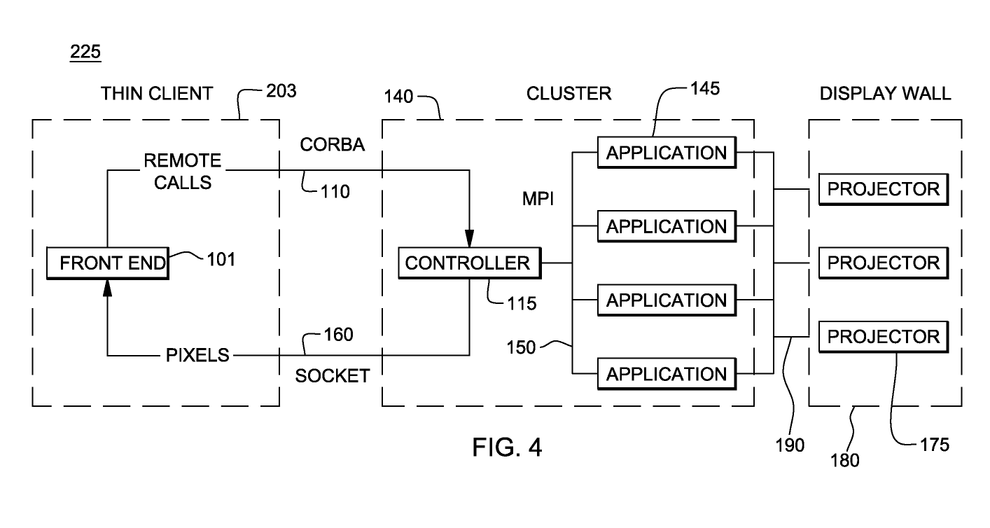

FIG. 4 illustrates one example embodiment comprising a second scenario 225 adapted to provide a design review with a display wall. In this embodiment, the back-end cluster 140 uses a “sort-first” rendering paradigm to address the situation of the rendering task being too great for a single rendering node, e.g., thin client device 203. For example, this could be due to the visualization data size being too large and/or the display resolution being too great for a single node. The data to be rendered is partitioned based on their screen position at a given frame.

It is understood that the two scenarios 200, 225 depicted in FIGS. 3 and 4 respectively, are the most common scenarios, however, the present invention does not preclude itself from being extended, customized, or adapted to address other problems, situations and scenarios. For example, if the user needs to develop a mechanism to track or a steer a separate parallel simulation process, the controller and server objects are extended to do so. Another example is when there is a unique data format that needs to be used as input. The servers can be customized to use special data readers to allow for these new data formats. Thus, the invention is extendable by creating shared libraries which will act as “plug-ins” to the initial architecture. By using this “plug-in” system, a developer can extend the invention to meet their visualization requirements.

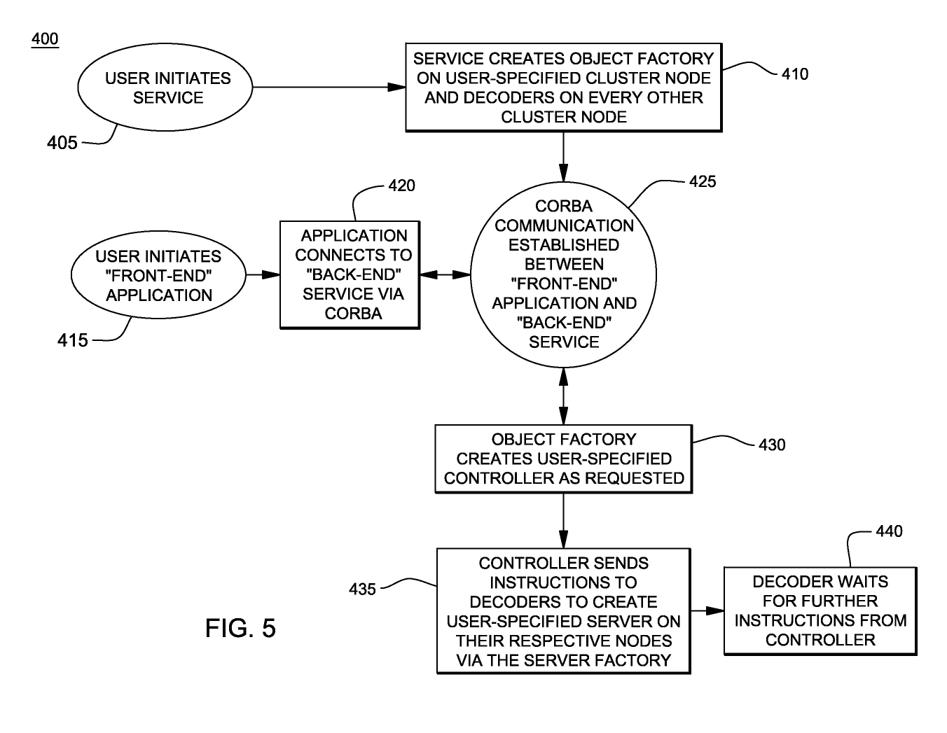

FIG. 5 illustrates an initialization procedure 400 for generating a new graphics application using the visualization design framework for interactive visualization of data in a graphics cluster according to the invention. These steps illustrated in FIG. 5 configure the resulting system architecture 100 as illustrated in FIG. 2.

As shown in FIG. 5, step 405, the user first runs a service start-up script to initialize the system. The input for the script is a configuration file specifying which nodes will be part of the system and which node are to contain an Object Factory and which nodes will contain the Decoders. As referred to herein, a “node” is a single server device on which an application runs. Thus, in FIGS. 3 and 4, the “cluster” is a set of four separate rendering server devices 140. However, it is understood that the present invention works when each application is a wholly separate “process” which is running on a single server device.

In FIG. 5 at 410, the service start-up script then executes procedure call and functionality to create the Object Factory and Decoders on the appropriate user-specified nodes. Then, as shown in FIG. 5, at 415, the user executes (runs) the “front-end” application script on the node on which the visualization application is to be run. The input for this script is the type of Controller (e.g. sort-first, sort-last, server-side simulation, etc.) that is to be created as well as another configuration file that describes the type of Server object (Renderer, Displayer, or both) that should be created by each Decoder object on its respective cluster node. Upon execution of this script at 415, the application “front-end” connects to the “back-end” service through a Front-End to Back-End Communications Layer 420 by establishing a CORBA® communication between the Front-End and Service at 425. This, Front-End to Back-End Communications layer is responsible for defining the interface between front-end application and the back-end cluster and is implemented using an object-specific middleware, e.g., an Object Request Broker (ORB). In an example embodiment, a CORBA® object request broker standard is implemented to allow for the “front-end” visualization application to be written in a variety of languages. Once this connection is established, resulting in the system architecture 100 of FIG. 2, the Object Factory creates the user-specified Controller object at 430 and then sends instructions to a Decoder(s) object to create their user-specified Server object 435 via a server factory component. As mentioned, the controller mechanism passes requests (e.g., render the frame) and information (e.g. the new Camera settings) from the “front-end” application to the appropriate Servers. The instantiated Controller determines where to route requests and information based on a variety of factors including the type of parallel rendering paradigm that is being employed (sort-first, sort-last) and other potential factors (e.g. load balancing results from a Tile Manager in a manner such as described in commonly-owned, co-pending U.S. patent application Ser. No. ______ [Atty. Docket No. YOR920090059US1 (24069)]).

After creating the desired type of controller at the graphics cluster, the Server Factory object is implemented that maintains a collection of functions that create “Server” objects responsible for rendering and displaying graphics at the cluster in accordance with a user-defined rendering technique. In addition, the Server Factory registers each Server object's name and maps the routine that creates that Server to the name. This facilitates runtime creation of any type of registered Server based on the designation by the front-end application.

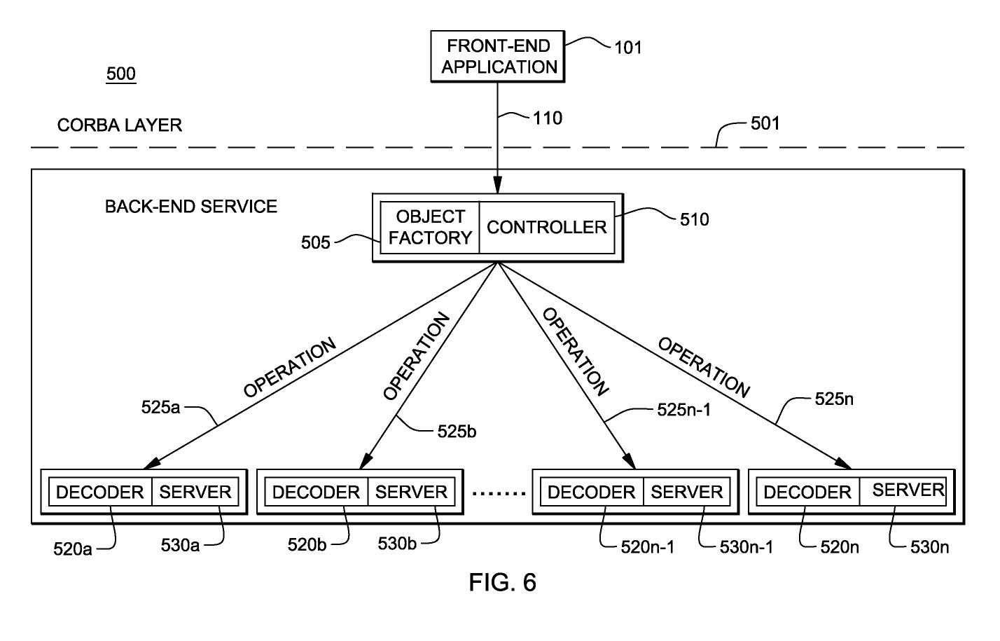

In one embodiment, as shown in FIG. 6 depicting a High-Level System Architecture and Operation forwarding techniques 500 according to the invention, the Object Factory 505 mechanism is invoked for creating a particular Controller object 515 and, although not shown in FIG. 6, creates an associated Camera object. The type of Controller created is user defined. The Object Factory 505 returns, to the Front-End applications 101 CORBA® references or handles (in one example implementation, over CORBA® layer 501) to these objects that exist only on the machine that the Object Factory 505 resides on. The Decoders 520a, . . . , 520n-1, 520n are mechanisms (instantiated objects) responsible for receiving Operations from the Object Factory 505 or Controller object 515 and, in one embodiment, responds to Operations 525a, . . . , 525n-1, 525n for performing the following actions, including, but not limited to: creating a Server object, destroying a Server object, obtaining the host name of the machine it resides on, or shutting down the process. If a Server object has been created, the Decoder object 520 forwards any Operations it does not understand to the Server. As referred to herein, Operation(s) 525a, . . . , 525n are object(s) that include an identification number (id) and an identifier for an associated function (opcode). The (id) indicates which Decoder object 520a, . . . ,520n or Server object 530a, . . . ,530n object should resolve the opcode. Although not shown, the respective Server object 530a, . . . ,530n resides on a cluster node that receives Operations 525a, . . . ,525n from the respective Decoder 520a, . . . ,520n or Controller 515.

Returning to FIG. 5, at 440, once of all of these components are created, the Decoder object(s) enter a tight loop and wait for further Operations from the user-defined Controller. If a Decoder receives an Operation it cannot resolve, it will forward the Operation to its respective Server. Once this occurs, communication between the Server and Controller is established until the task specified by the Operation is completed. Once the Operation is completed, communication between the Server and Controllers is ceased and communication between the Decoder and Controller is re-established. From this point on, the application can run as intended with Operations being sent from the “front-end” to the appropriate Servers where they are resolved and processed. A typical frequent Operation is for the Server to render its local data and forward the resulting pixels to the appropriate destination.

In view of FIG. 6, from this point on until system execution is halted, the operations work as follows: The user, via the “front-end” GUI 101 forwards events in the form of functions 110 to the Controller 515 on the “back-end” via CORBA® layer. Subsequently, the Controller 515 translates the received functions into Operations 525a, . . . ,525n (i.e., objects) and forward these Operations to the appropriate Decoders 520a, . . . 520n and/or Servers 530a, . . . ,530n (depending on if communication had already been established). Referring back to FIG. 2, the communication between the Controller and Decoders/Servers is currently implemented over Message Passing Interface (MPI) (e.g., MPI 2.1 Standard (June 2008)). The Servers in visualization cluster 140 will then process these Operations which typically include rendering the data. In one embodiment, a Rendering Server object is instantiated which is a type of Server that is invoked for processing the scene graph input. This processing typically means rendering the scene graph, producing pixels and then, based on the nature of the required distributed rendering paradigm employed, compositing the pixels, and forwarding the pixels to their final destination (e.g. the “front-end” display, a tiled display, etc.).

Once the data has been rendered, the pixels are then read back and then sent to either the “front-end” GUI 105 through a network socket communication 160 (e.g., as shown in desktop scenario 200 shown in FIG. 3) or, to one or more Displayer object processes 170 via MPI 190 (e.g., as shown in the design review with display wall scenario 300 shown in FIG. 4). The Displayer object(s) 170, which are a type of Server object, do not perform any rendering; rather, they only receive pixels from Servers that are rendering and place them in its associated display window of the graphics cluster. This allows specific cluster nodes to be used solely for displaying pixels, rendering pixels, or both which enhances the ability of the system to adapt to varying cluster and display scenarios. The pixels are then communicated to their destinations over a Digital Visual Interface (DVI) 195. At any time, the application “front-end” can be halted and, while the “back-end” service is still running, a new “front-end” can be started and connected to the same service. For complete system termination, the “back-end” service must be halted as well.

In accordance with the preferred embodiments, the invention seeks to hide as much of the distributed programming complexity from the developer as possible. This complexity is a product of providing solutions to several core distributed visualization challenges. These challenges and their solutions include (but are not limited to): effectively distributing data across nodes by providing spatial subdivision data structures; addressing the variation in data access times by implementing separate threads for CPU processing, GPU processing, and I/O processing in order to hide the latency; providing effective load balancing by providing performance counters, adaptive tiling, and a tile manager mechanism; and, reducing the programming complexity by using familiar scene graph programming models and implementing distributed (virtual) shared memory with automatic synchronization and consistency.

The inventive components shown and described herein have been implemented as a set of C++ libraries. To develop applications using the design toolkit of the present invention, Servers and Controllers are written using (or extending) the provided components that export their functionality to the “front-end” application through the Front-End to Back-End Communication Layer. The “front-end” application can be written in any language (that is currently supported by an Interface Definition Language (IDL) compiler) using this exported functionality as appropriate.

The Engineer's Desktop, such as shown in the example system configuration of FIG. 3, and Design Review with Display Wall, such as shown in the example system configuration of FIG. 4, are two of the most common scenarios. The Engineer's Desktop scenario (see FIG. 3) employs a sort-last rendering paradigm to address the situation where a cluster of rendering nodes are producing pixels for a single display. Typically, in this scenario the data is too large to be rendered by a single rendering node and must be partitioned and distributed across the rendering cluster. The Design Review with Display Wall Scenario (see FIG. 4) uses a sort-first rendering paradigm to address the situation of the rendering task being too great for a single rendering node. This could be due to the data size being too large and/or the display resolution being too great for a single node. The data to be rendered is partitioned based on their screen position at a given frame. It is understood, however, that the Design Review with Display Wall scenario shown in FIG. 4 can also employ a “sort-last” rendering paradigm.

Although these two scenarios are the most common scenarios, the invention does not preclude itself from being extended, customized, or adapted to address other problems. For example, if the user needs to develop a mechanism to track or a steer a separate parallel simulation process, the Controllers and Servers can be extended to do so. Another example is if there is a unique data format that needs to be used as input. The Servers can be customized to use special data readers to allow for these new data formats. Thus, the visualization applications created by users can be extended by creating shared libraries which will act as “plug-ins” to the initial architecture. By using this “plug-in” system, a developer can extend the invention to meet their visualization requirements.

In one embodiment, the system components are implemented using C++ on both Linux and Windows operating systems. One example rendering cluster for use as a design platform includes eight Intellistations, however the invention is not so limited. Each Intellistation uses NVIDIA graphics cards for rendering and are connected via Infiniband fabric.

In one embodiment, MPI may be used for communication between the nodes in the rendering clusters. Depending on the destination MPI or sockets are used for pixel transmission. CORBA® is used to send user events and functions from the “front-end” to the “back-end service”. As CORBA® is used in one embodiment, the “front-end” application can be written in any format that supports CORBA® (e.g. C++, Java, Python). The “front-end” application can be written with a variety of GUI APIs as well. Currently, “front-ends” can be implemented with GUIs written in wxWidgets, GLUT, and X/GLX.

Thus, the invention provides a new application framework for interactive visualization of large datasets. To address the dataset size challenge, the invention provides developers with efficient implementations of many optimization techniques such as spatialization, simplification, view-frustum culling, occlusion culling, multithreading, and prefetching. Spatialization is a process of building a hierarchical spatial data structure for a given dataset. Simplification is the process of precomputing and rendering approximate versions of a given dataset. View-frustum culling is an optimization technique that consists of only rendering geometery that is in the viewer's field of vision. Occlusion culling is similar to view-frustum culling but instead of culling or not rendering geometry outside the viewer's field of vision, occlusion culling eliminates geometry, from the rendering pipeline, that is completely hidden by other geometry. Multithreading refers to the use of multiple threads to accomplish different computing tasks (e.g. culling, rendering, fetching, etc.) concurrently which can improve performance. Prefetching is an optimization technique that seeks to bring into memory objects that may soon become visible so that they are readily available for the rendering thread. To address the parallelization challenge, the invention focuses on clusters of inexpensive PCs, supporting the sort-first and sort-last parallel rendering strategies, and providing a distributed shared memory mechanism that gives programmers the illusion that all machines have all the data at all times. To support multiple low-level rendering libraries, the invention separates modeling from rendering so that the same scene can be rendered by different back-ends (e.g., OpenGL, DirectX, or ray tracing). The invention thus extends the concept of a scene graph, applying many design patterns (e.g., smart pointers, factories, observers, and visitors), and providing registry and plug-in mechanisms for extensions of shape classes, rendering algorithms, and file formats.

In another aspect of the invention, the design toolkit creates a spatial hierarchy for a given dataset. As stated previously, Spatialization is a process of building a hierarchical spatial data structure for a given dataset. Examples of such structures include octrees, k-d trees, BSP trees, trees of bounding boxes, and trees of bounding spheres which structures have been used in many different contexts to speed up geometric algorithms. For example, when it is desired to find the closest object hit by a ray without a spatial hierarchy, every object in the scene would have to be tested. With a spatial hierarchy, when a ray does not hit a certain node in the hierarchy, it is known that the ray will not hit any of the descendants of that node either, and thus, that entire subtree can be pruned. Spatial data structures can also be used for out-of-core rendering. The size of the structure of the hierarchy is typically tiny in comparison to the size of the contents of the nodes in the hierarchy. As long as the RAM can hold the structure of the hierarchy and the contents of a single node, an arbitrarily large dataset can be rendered by swapping nodes in and out of memory.

The visualization design toolkit uses out-of-core techniques to support arbitrarily large datasets (limited only by the size of secondary memory, not RAM). The toolkit recursively splits spatial scene graph nodes until all spatial leaves satisfy a given limit on the number of geometric primitives per leaf. For example, it is useful to limit the number of vertices of indexed primitive arrays to be less than 64K, so that indices can be stored in 16-bit integers. The invention supports hierarchies of boxes and k-d trees.

To address usability, the present invention addresses the concept of a “scene graph”. In particular, the present invention provides classes for many typical scene graph nodes such as shape, material, light, and group. At the same time, the invention provides clean interfaces to encapsulate concepts such as sort-first and sort-last rendering. The scene graph programming model is a data structure provided in graphics APIs and applications such as AutoCad, OpenSceneGraph, OpenSG, and many others.

The visualization toolkit for handling scene graph programming model according to the present invention is now described in greater detail. The design toolkit utilizes a native scene graph structure to represent scenes and render data. By using scene graphs, a visualization application is able to implement a number of effective optimization techniques (e.g. visibility culling). Furthermore, it allows users to write input files that can reuse nodes, or groups of nodes, in a compact, and efficient manner. The scene graph, in one embodiment, uses three basic node types: Nodes, Components, and Attributes. A Node is the most fundamental application scene graph node and is embodied as Models, Volume Models, and Groups classes. Models and Volume Models are both “Nodes” that contain and describe the data to be rendered with “Models” describing polygonal data while “Volume Models” describe volumetric data. Models and Volume Models can be children of Groups but they cannot be parents of other Nodes themselves. Groups are Nodes that may have other Nodes as children. There are several Nodes that are derived from Groups and share the same characteristics. These Nodes include Hierarchical transform, Switch, and Spatial nodes embodied as classes. The Hierarchical Transform is a Group that applies transformations to all of its children. A Switch is a Group that provides selective rendering of its children. Lastly, a Spatial is a Group that facilitates the construction of spatial hierarchies as it contains thresholds (e.g. maximum number of triangles) that once the total “cost” of each of its children exceed this threshold, the Spatial creates two new children that are Spatials themselves. Each of these new Spatials include a partition of the original set of children.

One type of scene graph node is a “Component” that can be associated with a Model or Volume Model. Components are not treated as Nodes and are not children of other nodes nor can they be parents. Examples of Component nodes include the Shape, Look, Shader program, Transform, Data Volume, and Texture Volume nodes embodied as respective classes. For instance, a Model node can have four Components associated with it: Shape, Look, Shader Program, and Transform. A “Shape” component describes the type of polygonal shape that comprises the Model node it is associated with. Types of Shape components include: Sphere, Box, Cube, Cylinder, Plane, and Primitive Array. Primitive Arrays support many types of primitives, including lines, line loops, line strips, points, polygons, quads, quad strips, triangles, triangle fans, and triangle strips. Both indexed and non-indexed versions are allowed. A “Look” component describes the appearance of the Model it is associated with. The description is provided by a set of Attributes that describe properties such as the color, material, and texture properties. “Shader Program” components designate what, if any, shader program should be used in rendering the Model or Volume Model. A “Transform” component provides a transformation that is only to be applied to the associated Model. “Data Volume” and “Texture Volume” components describe three dimensional data and textures, respectively, that should be associated with a Volume Model node.

Similar to Components, Attributes are not treated as Nodes and cannot be parents or children of other scene graph model nodes. Attributes are associated with Components and describe particular properties of a Component. An Attribute can be a scene graph node such as Line Attributes, Polygon Attributes, or Color Material Attributes embodied as respective classes. Attributes can also be individual or an array of values that are specified in the actual scene graph file.

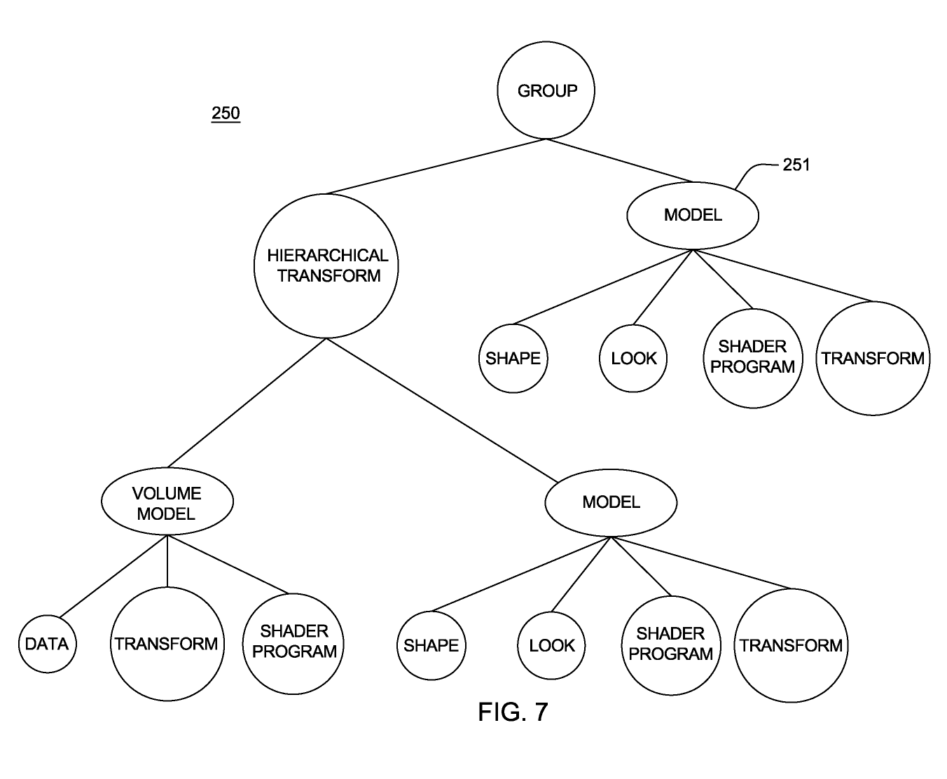

FIG. 7 illustrates how Group nodes can be used in a scene graph 250. In view of the example scene graph of FIG. 7, one Model node 251 has four Components associated with it: Shape, Look, Shader Program, and Transform.

The visualization cluster design toolkit supports several file formats and can read data files as well as write data files written in these formats. One of these data formats is an “OBJ”-type format; however, other formats, e.g., (ASCII) text format and binary formats may be implemented. The Readers and Writers are system components, implemented as C++ classes, that facilitate the reading of and writing of particular data formats, respectively. Readers and Writers for additional formats may be created and demonstrate how the invention is customizable to support new and unique types of data formats. In all cases, it is noted that the top-most node in a scene graph must be a Group, or a node derived from Group, such as Hierarchical Transform, Spatial, or Switch.

In one embodiment, one API function call that can be accessed invokes functionality which allows the Front-End applications to modify the scene graph loaded on the Servers. To enable this capability, the application performs the following: first, invoking an object that prompts the application to assign unique integer identifiers to each of the nodes in the scene graph (which are consistent across all the Servers). The Controller also returns to the Front-End application a complete description of the scene graph, including (for each node) the unique identifier, the type of node, the parent id, the children it has, etc. This description is then be used by the Front-End to allow the user to select specific nodes and modify them in various ways, e.g. adding new nodes, deleting nodes, modifying the properties of the nodes, disabling the nodes. The user may access many API calls related to modifying the scene graph from the Front-End application, including a Parallel Renderer Front-End which may be built with wxWidgets.

In sum, the invention provides an API that allows users to write complex graphics and visualization applications with little knowledge of how to parallelize or distribute the application across a graphics cluster.

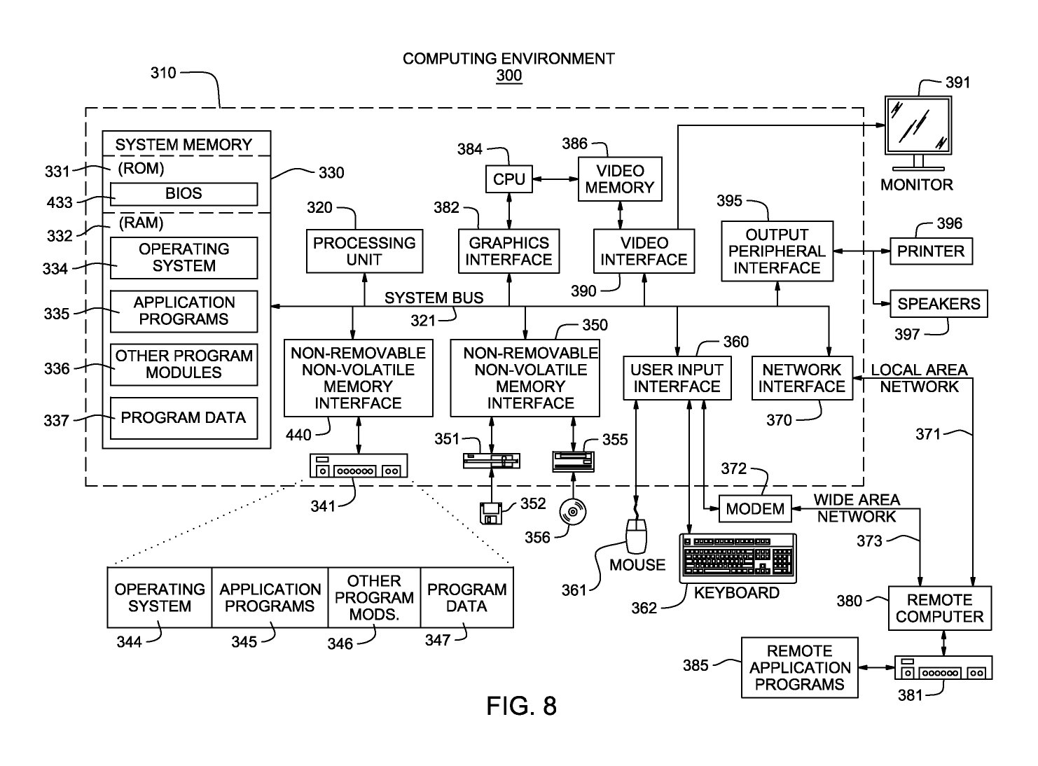

The method of the present invention will be generally implemented by a computer executing a sequence of program instructions for carrying out the steps of the method and may be embodied in a computer program product comprising media storing the program instructions. For example, FIG. 8 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations.

Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 8, thus, illustrates an example of a suitable computing system environment 300 in which the invention may be implemented, although as made clear above, the computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

With reference to FIG. 8, an exemplary system for implementing the invention includes a general purpose-computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 310.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 8 illustrates operating system 333, application programs 335, other program modules 336, and program data 337.

The computer 310 may also include other removable/non-removable, volatile/nonvolatile computer storage media. By way of example only, FIG. 8 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 8 provide storage of computer readable instructions, data structures, program modules and other data for the computer 310. In FIG. 8, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies.

A user may enter commands and information into the computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB).

A monitor 391 or other type of display device is also connected to the system bus 321 via an interface, such as a video interface 390. A graphics interface 382, such as Northbridge, may also be connected to the system bus 321. Northbridge is a chipset that communicates with the CPU, or host-processing unit 320, and assumes responsibility for accelerated graphics port (AGP) communications. One or more graphics processing units (GPUs) 384 may communicate with graphics interface 382. In this regard, GPUs 384 generally include on-chip memory storage, such as register storage and GPUs 384 communicate with a video memory 386. GPUs 384, however, are but one example of a coprocessor and thus a variety of co-processing devices may be included in computer 310. A monitor 391 or other type of display device is also connected to the system bus 321 via an interface, such as a video interface 390, which may in turn communicate with video memory 386. In addition to monitor 391, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 8. The logical connections depicted in FIG. 8 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 8 illustrates remote application programs 385 as residing on memory device 381. It will be appreciated that the network connections shown are exemplary and other means of establishing a communications link between the computers may be used.

One of ordinary skill in the art can appreciate that a computer 310 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method for controlling rendering of visualization data at one or more display devices associated with one or more server computing devices forming a visualization graphics cluster, said method comprising:
generating, for display at a front end client computing device, a user interface receiving user input for enabling interaction with said one or more server computing devices of said visualization graphics cluster;
accessing, in response to received user input, application programming interface (API) functions comprising computer readable instructions for configuring rendering and displaying images at said one or more display devices of said graphics cluster; and,
instantiating, via said API functions, one or more back end processes at said one or more server computing devices for parallelizing rendering tasks associated with display graphics rendering in said visualization graphics cluster,
wherein multiple user-defined rendering engines are dynamically configured for parallel rendering under user control.

2. The method as claimed in claim 1, wherein a back end process comprises a controller process responsive to API function calls for generating a scene graph model for display at said graphics cluster, said scene graph model specifying one or more scene graph nodes having associated data and descriptions of how said data is to be rendered.

3. The method as claimed in claim 1, wherein said back end controller process invokes a server process associated with each said one or more scene graph nodes that is responsible for rendering a scene graph by generating resulting pixels for a display.

4. The method as claimed in claim 3, wherein said server process invokes a further rendering process for rendering a scene graph according to a user defined technique, said rendering process decoupled from said scene graph model.

5. The method as claimed in claim 4, wherein a user defined rendering process for rendering a scene graph implements a rendering API.

6. The method as claimed in claim 4, wherein a user defined rendering process for rendering a scene graph implements ray-tracing.

7. The method as claimed in claim 1, wherein said back end controller process invokes a displayer process receiving said resulting pixels from a server process for display at a display device of said graphics cluster.

8. The method as claimed in claim 3, further comprising: invoking a back end decoder process for receiving messages from said back end controller process and communicating said messages to said server process, a message comprising scene graph rendering instructions for a scene graph node.

9. The method as claimed in claim 8, further comprising: communicating messages between said back end controller process and a server process via a Message Passing Interface (MPI).

10. The method as claimed in claim 7, wherein said front end client computing device communicates with said back end controller process via an object request broker.

11. The method as claimed in claim 10, wherein said received user input comprises a configuration file having content specifying creation of said back end controller process.

12. The method as claimed in claim 11, wherein said back end controller process is a controller process responsive to API function calls for rendering a display at said graphics cluster according to a sort-first parallel rendering algorithm.

13. The method as claimed in claim 2, wherein said back end controller process is responsive to API function calls for rendering a display at said graphics cluster according to a sort-last parallel rendering algorithm.

14. The method as claimed in claim 2, wherein said back end controller device is responsive to API function calls for creating a camera object associated with said controller.

15. The method as claimed in claim 13, further comprising, configuring a back end process for forwarding said resulting pixels back to a display device associated with said front-end client computing device via a network socket communication.

16. A computer system for controlling rendering of visualization data at one or more display devices associated with one or more server computing devices forming a visualization graphics cluster, said computer system comprising:
a memory;
a processor in communications with the computer memory, wherein the computer system is capable of performing a method comprising:
generating, for display at a front end client computing device, a user interface receiving user input for enabling interaction with said one or more server computing devices of said visualization graphics cluster;
accessing, in response to received user input, application programming interface (API) functions comprising computer readable instructions for configuring rendering and displaying images at said one or more display devices of said graphics cluster; and,
instantiating, via said API functions, one or more back end processes at said one or more server computing devices for parallelizing rendering tasks associated with display graphics rendering in said visualization graphics cluster,
wherein multiple user-defined rendering engines are dynamically configured for parallel rendering under user control.

17. The computer system as claimed in claim 16, wherein a back end process comprises a controller process responsive to API function calls for generating a scene graph model for display at said graphics cluster, said scene graph model specifying one or more scene graph nodes having associated data and descriptions of how said data is to be rendered.

18. The computer system as claimed in claim 16, wherein said back end controller process invokes a server process associated with each said one or more scene graph nodes that is responsible for rendering a scene graph by generating resulting pixels for a display.

19. The computer system as claimed in claim 18, wherein said server process invokes a further rendering process for rendering a scene graph according to a user defined technique, said rendering process decoupled from said scene graph model.

20. The computer system as claimed in claim 16, wherein said back end controller process invokes a displayer process receiving said resulting pixels from a server process for display at a display device of said graphics cluster.

21. The computer system as claimed in claim 18, further comprising: invoking a back end decoder process for receiving messages from said back end controller process and communicating said messages to said server process, a message comprising scene graph rendering instructions for a scene graph node, wherein said messages are communicated between said back end controller process and a server process via a Message Passing Interface (MPI).

22. The computer system as claimed in claim 21, wherein said front end client computing device communicates with said back end controller process via an object request broker.

23. The computer system as claimed in claim 22, wherein said received user input comprises a configuration file having content specifying creation of said back end controller process.

24. The computer system as claimed in claim 23, wherein said back end controller process is a controller process responsive to API function calls for rendering a display at said graphics cluster according to a sort-first parallel rendering algorithm.

25. The computer system as claimed in claim 23, wherein said back end controller process is responsive to API function calls for rendering a display at said graphics cluster according to a sort-last parallel rendering algorithm.

26. The computer system as claimed in claim 25, capable of performing a method comprising configuring a back end process for forwarding said resulting pixels back to a display device associated with said front-end client computing device via a network socket communication.

27. A computer program product for controlling rendering of visualization data at one or more display devices associated with one or more server computing devices forming a visualization graphics cluster, said computer program product comprising:
a storage medium readable by a processing circuit and storing instructions for execution by the processing circuit for performing a method comprising:
generating, for display at a front end client computing device, a user interface receiving user input for enabling interaction with said one or more server computing devices of said visualization graphics cluster;
accessing, in response to received user input, application programming interface (API) functions comprising computer readable instructions for configuring rendering and displaying images at said one or more display devices of said graphics cluster; and,
instantiating, via said API functions, one or more back end processes at said one or more server computing devices for parallelizing rendering tasks associated with display graphics rendering in said visualization graphics cluster,
wherein multiple user-defined rendering engines are dynamically configured for parallel rendering under user control.
